(19) United States
(12) Patent Application Publication
(10) Pub. No.: US 2008/0201163 A1
(43) Pub. Date: Aug. 21, 2008

(54) Vehicle-Value Analyzing and Messaging Systems

(76) Inventors: Jolyon Barker, Oldbury (GB); Paul Bennett, Oldbury (GB)

Correspondence Address: LAW OFFICE OF ANDREW P. LAHSER, PLC, 13239 N. LA MONTANA, SUITE 215, FOUNTAIN HILLS, AZ, 85268, US

(21) Appl. No.: 12/033,846

(22) Filed: Feb. 19, 2008

Related U.S. Application Data
(60) Provisional application No. 60/902,273, filed on Feb. 20, 2007.

(51) Int. Cl. G06Q 99/00

(52) U.S. Cl. 705/1

(57) ABSTRACT

A system, process and computer software is disclosed for electronically accessing financial terms related to the acquisition of a vehicle by a purchaser, including contact information, original vehicle information, and the settlement amount. This system may electronically accesses used vehicle valuations, including an estimate for a vehicle similar to the vehicle included with the financial terms. The system may automatically correlate the financial terms to the used vehicle valuations. The system may determine the value-difference between the financial terms of the original vehicle and a new vehicle. The system may transmit a message to the purchaser to communicate that the purchaser can replace the original vehicle with a new vehicle.

### CROSS REFERENCE TO RELATED APPLICATIONS

The present application is related to prior provisional application Ser. No. 60/902,273, filed Feb. 20, 2008, the contents of which are incorporated herein by this reference and are not admitted to be prior art with respect to the present invention by the mention in this cross-reference section.

### BRIEF DESCRIPTION OF THE DRAWINGS

FIG. 1 shows a use-case diagram illustrating an end user sorting purchaser information by evaluating information from vehicle financiers, vehicle manufacturers and vehicle appraisers and inputting adjustments to reflect current market conditions to determine when a purchaser can replace their current vehicle for no additional monthly payment, according to an embodiment of the present invention.

FIG. 2 shows an architecture diagram illustrating a computer-network system that shows the relationships between a computer system for organizing the value-difference information, a database for allowing accessing of information, the external systems for providing updated information and communication systems for messages regarding this information, according to an embodiment of the present invention.

FIG. 3 shows an entity relationship diagram (ERD) illustrating database entities and attributes that store financial information and database relationships to used-vehicle valuation entities and other entities, according to an embodiment of the present invention.

FIG. 4 shows an entity relationship diagram illustrating database entities storing adjustment information in a class/subclass relationship, according to the embodiment of FIG. 3.

FIG. 5 shows a sequence diagram illustrating a course of action for a computer software program to determine the value-difference between the original financial terms and the new financial terms, according to an embodiment of the present invention.

FIG. 6 shows a bar graph comparing the portions of the value of the original financial terms to the portions of the value of the new financial terms, according to an embodiment of the present invention.

FIG. 7 shows a data flow diagram illustrating the data flow for calculating the value difference between a new vehicle acquisition and the present value of a financed vehicle, according to an embodiment of the present invention.

FIG. 8 shows a data flow diagram illustrating the process for calculating the remaining interest to be paid in order to remove such interest from consideration of the value difference, according to the financial terms of a vehicle acquisition, according to an embodiment of the present invention.

FIG. 9 shows a diagrammatic view illustrating a telephone correspondence between a vehicle dealer and a vehicle purchaser regarding the replacement of the original vehicle with a new vehicle without increasing payment, according to an embodiment of the present invention.

FIG. 10 shows a diagrammatic view illustrating an automatically generated text message of correspondence to the purchaser regarding the replacement of the original vehicle with a new vehicle without increasing payment or requiring additional cash, according to an embodiment of the present invention.

FIG. 11 shows a diagrammatic view illustrating an automatically generated facsimile message of correspondence to the purchaser regarding the replacement of the original vehicle with a new vehicle without increasing payment or requiring additional cash, according to an embodiment of the present invention.

FIG. 12 shows a diagrammatic view illustrating an automatically generated email message of correspondence to the purchaser regarding the replacement of the original vehicle with a new vehicle without increasing payment or requiring additional cash, according to an embodiment of the present invention.

FIG. 13 shows a computer screenshot view illustrating a web application containing a login screen for an end user, according to an embodiment of the present invention.

FIG. 14 shows a computer screenshot view illustrating how an end user may view purchaser information and how an end user may enter trading, marketing, customer and price adjustment information, according to an embodiment of the present invention.

FIG. 15 shows a computer screenshot view illustrating how an end user may enter original interest information and new interest information, according to an embodiment of the present invention.

FIG. 16 shows a computer screenshot view illustrating how an end user may enter sorting criteria, such as vehicle make, vehicle model, financing type, and other details, according to an embodiment of the present invention.

FIG. 17 shows a computer screenshot view illustrating how an end user may enter trading adjustments and the selling price of a new vehicle in order to re-determine the value difference for each purchaser, according to an embodiment of the present invention.

FIG. 18 shows a computer screenshot view illustrating how an end user may enter adjustments without entering the selling price of a new vehicle in order to re-determine the value difference for each purchaser, according to an embodiment of the present invention.

FIG. 19A shows a top-half of computer screenshot view and FIG. 19B shows a bottom-half of the same view illustrating how an end user may view contact information for a purchaser in order to deliver a message regarding the replacement of their vehicle, according to an embodiment of the present invention

### DETAILED DESCRIPTION

The present Vehicle-Value Analyzing and Messaging Systems will now be discussed in detail with regard to the attached drawing figures, which were briefly described above. In the following description, numerous specific details are set forth illustrating the Applicant's best mode for practicing the Vehicle-Value Analyzing and Messaging Systems and enabling one of ordinary skill in the art to make and use the Vehicle-Value Analyzing and Messaging Systems. It will be obvious, however, to one skilled in the art that the present Vehicle-Value Analyzing and Messaging Systems may be practiced without many of these specific details. In other instances, well-known software systems, software methods, business methods and other method steps have not been described in particular detail in order to avoid unnecessarily obscuring this disclosure.

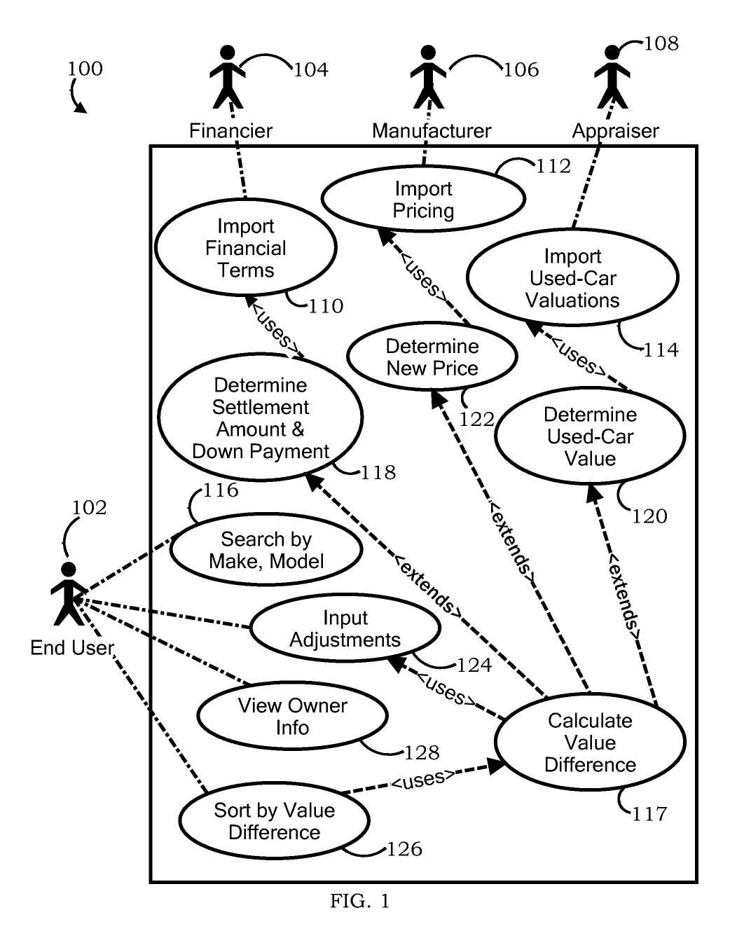

FIG. 1 shows a use-case diagram illustrating end user 102 using system 100 to sort purchaser information by evaluating information from vehicle financiers 104, vehicle manufacturers 106 and vehicle appraisers 108 and inputting adjustments 124 to reflect current market conditions to determine when a purchaser can replace their original vehicle for no additional monthly payment, according to an embodiment of the present invention. System 100 may receive data from external sources, such as, for example, vehicle financier 104, vehicle manufacturer 106, and vehicle appraiser 108, as shown. Vehicle financier 104 may provide various financing methods to potential purchasers of vehicles, such as, for example, conventional loan financing, close-ended leases, open-ended leases, etc. Vehicle manufacturer 106 may produce vehicles for potential purchasers, such as, for example, private passenger automobiles, private passenger light trucks, private passenger vans and other four-wheeled, private passenger vehicles for driving on public highways. Alternately, vehicle manufacturer 106 may produce other types of vehicles, such as, for example, motorcycles, recreational vehicles, boats, lorries, long-haul trucks, private aircraft and other types of vehicles which are purchased using financing. Vehicle appraiser 108 may provide services or data to estimate the value of a used vehicle. System 100 may import data from these external sources, as shown.

To import data from the external sources, system 100 may use varies system functions, as shown. To import data from vehicle financier 104, system 100 may use import-financial-term function 110, as shown. To import data from vehicle manufacturer 106, system 100 may use import-pricing function 112, as shown. To import data from vehicle appraiser 108, system 100 may use import-use-car-valuations function 114, as shown. After importing data, end user 102 may query the system, as shown.

System 100 provides end-user 102 with the ability to find original vehicle owners who would presently be able to purchase a new model year vehicle (with the same make and model), using the same financing method, with the same payment amount, with no additional down payment, by replacing their original financing arrangement with a new financing arrangement having a longer term. End user 102 may search for these vehicle owners by using the search-by-make-model function 116, as shown. Search-by-make-model function 116 may sort through the financial terms data that was imported by the import-financial-terms function 110 and display a set of this vehicle owner data pertaining to financial records for the vehicle make, vehicle model, or other vehicle classification that was specified by end user 102, as shown.

When displaying this set of this vehicle owner data, system 100 may also display the value-difference between the financial terms of the original vehicle versus the financial terms of the new vehicle. To do this, system 100 may use calculate-value-difference 117, as shown. Calculate-value-difference 117 may use a series of steps to calculate this value-difference. Calculate-value-difference 117 may begin by accessing the financial terms for each vehicle imported, for example, by using determine-settlement-amount-and-down-payment function 118 to determine the current settlement amount and the original down payment, as shown. Calculate-value-difference 117 may continue by determining the value of the vehicle specified in the financing terms, for example, system 100 may use the determine-used-car-value function 120 with the vehicle make, vehicle model and other conditions specified by the financing terms to determine a value for the original vehicle by comparing it to the data obtained from vehicle appraiser 108 using import-used-car-valuations function 114, as shown. System 100 may determine the value of the new vehicle. System 100 may determine the new vehicle price by using determine-new-price function 122, which will provide the price for the new vehicle specified by the vehicle make, vehicle model, vehicle year and other conditions specified by the financing terms. Alternatively, end-user 102 may supply system 100 with the desired new vehicle pricing information and the new vehicle pricing information would not be provided directly to system 100 by vehicle manufacturer 106. Finally, calculate-value-difference 117 may compare the original financing terms, the current settlement amount, the original vehicle's estimated value, the original down payment amount, the new car price, and the new car financing terms to determine the difference in value between the original financing terms and the new (proposed) financing terms, as shown.

End-user 102 may have knowledge of local vehicle markets. Whenever end user 102 may be a vehicle dealer, end user 102 may also have needs for specific types and kinds of used vehicles. System 100 allows end-user 102 to indicate adjustments by using input-adjustments function 124 by specifying changes in the value-difference for a specific vehicle, whether by make, model, color, or optional equipment, as shown. For example, if a vehicle dealer may need used Honda Civics, then the vehicle dealer may be willing to offer an additional $1000 incentive for trading in a Honda Civic. For further example, if a vehicle dealer may have a relationship with a new local credit union that is offering lease financing with higher than average residual payments, so the vehicle dealer may be able to adjust the value difference because it may be able to offer promotional financing. End-user 102 may enter such adjustments using input-adjustments 124, as shown. System 100 may then use calculate-value-difference function 117, which uses the adjustments received by input-adjustments function 124, to determine the new value-difference, as shown.

After inputting adjustment for local market conditions, system 100 may again display the vehicle information, the owner information, and their corresponding value-differences. End-user 102 may wish to sort the vehicle owners by their value difference using the sort-by-value-difference function 126, as shown. End-user may then view only the set of vehicles and owners where the positive value of the new financing terms meets or exceeds the value of the original financing terms, that is, the vehicle owner may be able to exchange the original vehicle for a new vehicle without increasing the monthly payment amount and without depositing additional cash when trading in the original vehicle for the purchase of the new vehicle. Such a situation may be indicated by a positive or zero value-difference amount. Alternatively, end-user 102 may search for value-differences that are negative but close to zero, for example, value-differences that are less than one months payment, value-differences that are less than a fixed amount, value-differences that are lower than the original down payment amount.

End-user 102 may then wish to contact these vehicle owners, by using the view-owner-info function 128, as shown. End-user 102 may then attempt to contact the vehicle owner to sell them a new vehicle in exchange for their original vehicle. Alternatively, system 100 may provide automated methods for transmitting messages to the vehicle owner.

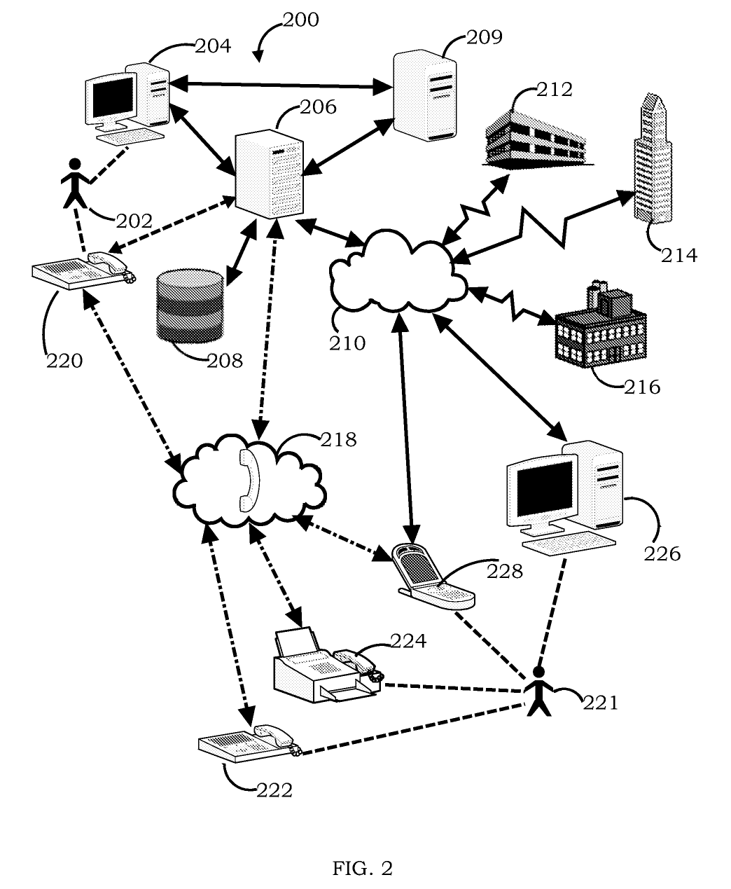

Turning now to next figure, FIG. 2 shows a computer software architecture diagram illustrating computer-network system 200 that shows the relationships between computer system 206 for organizing the value-difference information, database 208 for allowing accessing of information, the external systems for providing updated information and communication systems for messages regarding this information, according to an embodiment of the present invention. End user 202 may use personal computer 204 to access web-server 206, as shown. Web-server 206 may be configured, adapted or programmed to provide functions similar to functions described by system 100, as shown above. Alternatively, functions of system 100 may be adapted and configured to operate on personal computer 204, or an application server, or a database server, or other computerized system depending on the requirements of the computer system architecture. Web-server 206 may also be configured, adapted or programmed to provide additional functions and features as described in the various embodiments herein. Web-server 206 may be configured with an operating system, such as, for example, Windows Server. Alternately, other types of operating systems may suffice, such as, for example, Linux, Windows XP, Unix, etcetera. Web-server 206 may be configured with a web server appropriate for the installed operating system, such as, for example Windows IIS, Apache, AOL Server, or any other program configured to send and receive HTTP requests.

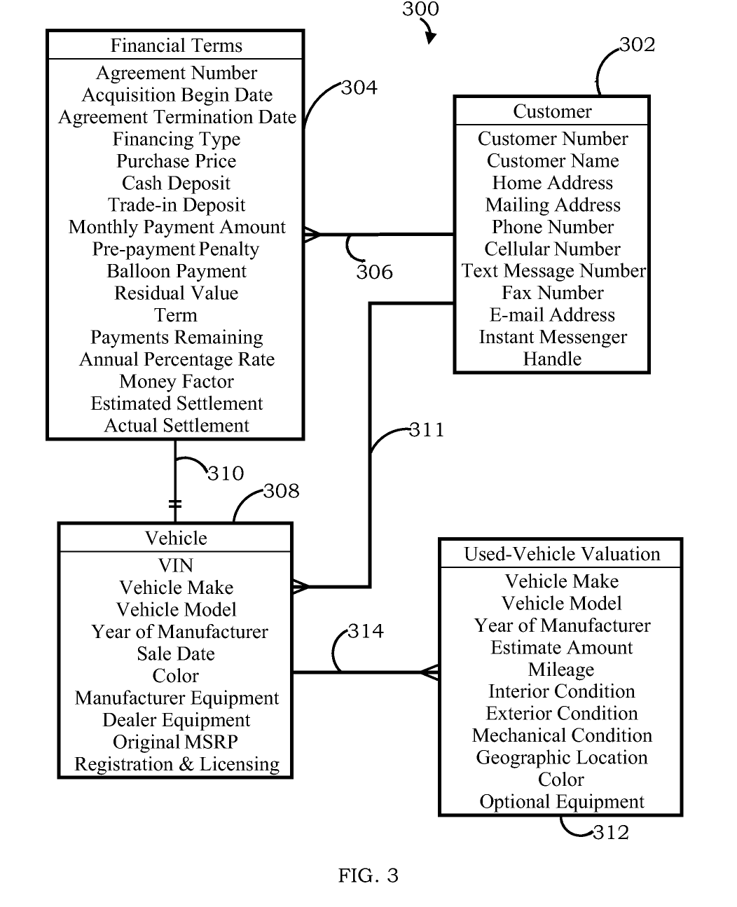

Database 208 may store data required by web-server 206, such as, for example, data obtained by import-financial-terms function 110 (see FIG. 1), data obtained by import-pricing function 112 (see FIG. 1), import-used-car-valuations functions 114 (see FIG. 1), input adjustments function 124 (see FIG. 1), customer entity 302 (see FIG. 3), financial-terms entity 304 (see FIG. 3), vehicle entity 308 (see FIG. 3), used-vehicle valuation entity 312 (see FIG. 3), and other data storage schemes as described in the various embodiments herein. Database 208 may be a relational database, such as, for example, relational (or quasi-relational) database provided under the trademarks or brands MySQL, SQL Server, Oracle, etc. Upon reading the teachings of this specification, those skilled in the art will now realize that, considering such issues as database features, data format, data quantity, economic considerations, advances in database technology, advances in Internet protocols or networked communications, etc., other types of database, such as, for example, relational database, object database, object oriented databases, flat-file file-systems, etcetera, may suffice.

Web-server 206 may communicate with Database 208 through a protocol, which may be specified by the provider of the database system, for example, web-server 206 may communicate with database 208 using T-SQL (transact-SQL) for the relational database SQL Server. Other database types may communicate through other protocols or through the operating system.

Web-server 206 may communicate with other systems. For example, web-server 206 may communicate with customer-relationship management system 209, as shown. Customer relationship-management system 209 may organize information related to customers of end-user 202. For example, if end-user 202 may be a vehicle dealership, the customer relationship management system may assist the vehicle dealership with tracking who said what and when to customers of the vehicle dealership. For example, if end-user 202 may be a vehicle manufacturer, the customer relationship management system may assist the vehicle manufacturer with tracking who said what and when to the vehicle dealerships affiliated with the vehicle manufacturer. For example, if end-user 202 may be a financial institution, the customer relationship management system may assist the financial institution with tracking who said what and when to the vehicle dealerships that provide their financial products and/or their vehicle purchasers with whom they have entered into financial service agreements. Web-server 206 may communicate with other systems that may benefit from knowing when a vehicle owner may be ready to purchase a new vehicle. Web-server 206 may communicate with other systems, such as customer relationship management system 209, using a flat file export, a xml (extended hypertext markup language), or by providing a services, such as, for example a web services using the HTTP or HTTPS protocol, or by other similar methods.

Web-server 206 may communicate across computer networks, such as, for example, local area networks, wide-area networks, Internet 210, as shown. Database 208 may be installed on the same computer as Web-server 206. Alternately, web-server 206 and database 208 may be deployed in a distributed environment with multiple physical machines communicating over a computer network. Web-server 206 may communicate with external data sources, including external databases, or external application services, or both, as shown. Web-server 206 may communicate with vehicle-appraisal company 212, financial institution 214 and vehicle manufacturer 216, across Internet 210, as shown. Alternately, such communication may occur across a private or secure network or using encryption. Financial institution 212 may provide secure access to data regarding the financial terms of vehicles financing agreements. Financial institution 212 may provided information related to promotional financing, standard financing terms, current financing terms, or other information. Vehicle-appraisal company 214 may provide public or private access to estimating data or estimating services for estimating the value of a used (or pre-owned) vehicle. Vehicle manufacturer 216 may provide public or private access to vehicle pricing, vehicle purchase incentive information, or promotional financing information.

Web-server 206 may access the information or data available from vehicle-appraisal company 212, financial institution 214 and vehicle manufacturer 216 and store such information into database 208, as shown. Web-server 206 may periodically, for example, daily, weekly, or hourly, update such information. Alternately, web-server 206 may access such external sources on a real-time basis, upon request of other functions of web-server 206 on behalf of end-user 202, as shown.

When end-user 202 desires to query system 200 to find potential vehicle-sales leads, end-user 202 may use personal computer 204 (configured with a web-browser) to access web-server 206, as shown. Web-server 206 may respond to the request using information from database 208, external sources, vehicle-appraisal company 212, financial institution 214, vehicle manufacturer 216 and other services or information available on the computer network or Internet 210, as shown.

After end-user 202 finds suitable leads, end-user 202 may desire to communicate with the potential purchasers of new vehicles. System 200 may provide an automatic method for communicating messages to potential purchasers, as shown. Web-server 202 may be configured or adapted to be connected to telephone network 218, as shown. Telephone network 218 may include POTS (Plain Old Telephone Service), cellular telephone networks, wireless text message networks (SMS), or wireless data services. Web-server 206 may initiate a telephone call on telephone network 218 using the contact information (for example, by producing the DTMF tones corresponding to a home, cellular or office phone number) from the potential purchaser, as shown. After dialing the telephone number, telephone network 218 may ring telephone 222 allowing potential purchaser 221 to answer the phone, as shown. Web-server 206 may be connected to a PBX switch, telephony server or communicate directly with an IP (Internet Protocol) phone as shown. Web-server 208 may transfer the server-initiated call (now connected to telephone 222 with potential purchaser 221 on the line) to the telephone of end-user 202, as shown. Web-server 206 may record the call attempt in database 208, as shown.

Web-server 206 may also send other types of messages across telephone network 208, as shown. For example, web-server 206 may contain templates of messages that may be transmitted to facsimile machine 224 connected to telephone network 218, as shown. Web-server 206 may customize the facsimile template using the owner information, including the owner's fax number, the terms of the original financing, the terms or the new (prospective) financing and vehicle, the vehicle estimate, or any other information helpful or useful in developing a message for encouraging the purchase of a new vehicle. Web-server 206 may transmit such facsimile message across telephone network 218 to fax machine 224 so that potential purchaser 221 may receive the message, as shown.

Web-server 206 may send a similar message formatted as a text message, for example, using SMS (Short Message Service) across a cellular telephone network, to cellular phone 228, which will ring, vibrate, or beep to alert potential purchaser 221, as shown. Web-server 206 may send a similar message formatted as a text message, for example, using an instant messaging service across Internet 210 to personal computer 226 which may alert potential purchaser 221, as shown. For instant messages, web-server 206 may be configured to check the online status of the potential purchaser prior to sending any instant message. Web-server 206 may send a similar message formatted as an email message, for example, using SMTP (Simple Mail Transfer Protocol), POP (Post Office Protocol), and/or IMAP (Internet Message Access Protocol) protocols across Internet 210 to personal computer 226 where potential purchaser can read the email in an email program, as shown.

Now consider FIG. 3, which shows an entity relationship diagram (ERD) illustrating database entities and attributes that store financial information and database relationships to used-vehicle valuation entities and other entities, according to an embodiment of the present invention. Database schema 300 may provide information about database entities, database attributes, relationships, and keys in a relational database, such as database 208 (see FIG. 2). Database schema 300 may contain tables for entities that require data storage, such as, for example, customer entity 302, financial terms entity 304, vehicle entity 308, and used-vehicle valuation entity 312, as shown.

Customer entity 302 may be related to financial terms entity 304 by one-to-many relationship 306 which may convey the notion that “one customer may have more than one financial terms,” for example, the customer may have more than one vehicle and each vehicle has its own financing agreement, as shown. Financial terms entity 304 may be related to vehicle entity 308 by a one-to-only-one relationship 310, which may convey the notion that “one financial terms may have one and only one vehicle,” for example, a financing agreement may require that a vehicle be transferred pursuant to the agreement, and, each vehicle may be required to have its own financing agreement. A customer may own a vehicle without financing, which may be indicated by one-to-many relationship 311, which conveys the notation that “one customer may own more than one vehicle,” and which, in the absence of any related financial terms, may further indicate that the customer owns the vehicle free and clear of any lien, encumbrance or other financing agreement, as shown. Vehicle entity 308 may relate to used-vehicle valuation entity 312 by one-to-many relationship 314, which may convey the notion that “a vehicle may have more than one vehicle estimate,” for example, the vehicle estimate may vary depending on the characteristics (age, mileage, equipment, color, location, etcetera) of the vehicle, as shown.

Customer entity 302 may contain various attributes to organize data related to the customer and the customer's contact information by its purpose and data-type, as shown. For example, customer number attribute may be the primary key of the customer entity 302, which may uniquely identify a customer within the customer entity. Customer number attribute may be a sequential, assigned number, and may be defined as a numeric data-type. Alternately, customer number attribute may be another uniquely identifying number, such as a phone number, and may be defined as character-string data-type. Customer name attribute would inform about the name of the customer, who would be the vehicle owner, and may be defined as a character-string data-type. Home address attribute would inform about the home address of the customer, and presumably, may be the location where the vehicle would be stored overnight, and may be defined as a character-string data-type. Mailing address attribute would inform about the mailing or billing address of the customer and may be defined as a character-string data-type. Phone number attribute, cellular number, text message number, and fax number would inform about the respective phone numbers and may be defined as a character-string data-type. Instant message handle would inform about the text messaging service, and may be a unique identifier provided by an Internet instant messaging service, and may be defined as a character-string data-type. E-mail address attribute would inform about the email address of the customer and may be defined as a character-string data-type.

Financial-terms entity 304 may contain various attributes to organize data related to the financial agreement for the purchase of the related vehicle, as shown. For example, agreement number attribute may be a unique number assigned by the system to uniquely identify the financial terms agreement, and may be defined as a numeric data-type. Alternately, agreement number attribute may be a number assigned by the financial institution facilitate communication and data exchange with the dealerships that sell its financial products. Acquisition begin date attribute and agreement termination date attribute may inform about the date that the owner acquired the vehicle and the date that the agreement may terminate if all payments are timely made, respectively. These may be defined as a datetime data-type. Financing type attribute may inform about the type of financial product, for example, conventional loan financing, close-end lease, open-end lease, etcetera. Purchase price attribute may inform about the original purchase price paid by the purchaser and may be defined as a money data-type. Cash deposit attribute may inform about the amount of cash that the customer originally paid to purchase the vehicle and may be defined as a money data-type. Trade-in deposit attribute may inform about the value of the trade that the dealership allowed for the purchase of the original vehicle and may be defined as a money data-type. The down payment amount (not shown) may be determined by adding the trade-in deposit to the cash deposit. The monthly payment amount attribute may inform about the amount that the purchaser may be obligated to pay each month and may be defined as a money data-type. The period of the payment may be other than monthly, for example, weekly, quarterly, annually, etcetera. Alternately, the period of the payment may be indicated as a attribute in the schema, rather than inferred directly by the schema definition as shown. Pre-payment penalty attribute may inform about any pre-payment penalty amount and may be defined as a money data-type. The balloon payment may inform about any balloon payment payable at the termination of the agreement and may be defined as a money data-type. The residual value attribute may inform about any residual value at the termination of lease financing terms and may be defined as a money data-type. The term attribute may inform about the original number of payments or the original length of time of the financing agreement. The payments remaining attribute may inform about the number of remaining payments and may be defined as an integer data-type. The annual percentage rate attribute and the money factor attribute may inform about the APR or money factor (respectively) applied to the outstanding balance of the financing terms and may be defined as a decimal, integer (e.g. storing 8.25% APR as 825 “points”) or other numeric data-type. The estimated settlement attribute may inform about the estimated settlement, which may be calculated by the system, and may be defined as a money data-type. The actual settlement attribute may inform about the actual settlement value that may be received from the financial institution party to the financing agreement. This attribute may be defined as a money data-type.

Vehicle entity 308 may contain various attributes to organize data related to the vehicle purchased by the customer, as shown. VIN attribute may inform about the vehicle information number (or other vehicle identifier physically located on a vehicle) and may be defined as a character-string data-type and may uniquely identify the vehicle. Vehicle make attribute may inform about the vehicle manufacturer and may be defined as a character-string data-type. Vehicle model attribute may inform about the vehicle model, including vehicle body type, or other classification information that may be required to accurately estimate the value of a vehicle. Year of manufacture attribute may inform about the time of manufacture of the vehicle. Sale date attribute may inform about the date of the original sale of the vehicle. Similarly, if the vehicle was purchased without any financing agreement (meaning that no related financial terms exist), the vehicle attribute may define additional attributes to track the original sale, such as, for example, down payment amount attribute, cash deposit attribute, trade-in deposit attribute, etc. Color attribute may inform about the color of the vehicle. Manufacturer equipment attribute and dealer equipment attribute may inform about the original equipment installed by the manufacturer and any after market equipment installed by the dealer. These attributes may be multi-valued and may also be defined as a separate entity or a super-data-type such as a linked list. Original MSRP attribute may inform about the original manufacturer suggested retail price and may be defined as a money data-type. Registration and licensing attribute may inform about the registration or licensing of the vehicle. These attributes may be multi-valued and may also be defined as separate entities.

Used-vehicle valuation entity 312 may contain various attributes to organize data related to estimating the value of the vehicles, as shown. Vehicle make attribute may inform about the vehicle manufacturer and may be defined as a character-string data-type. Vehicle model attribute may inform about the vehicle model, including vehicle body type, or other classification information that may be required to accurately estimate the value of a vehicle. Year of manufacture attribute may inform about the time of manufacture of the vehicle. Estimate amount attribute may inform about the minimum or maximum estimated value that of a vehicle. Mileage attribute may inform about minimum and maximum range of mileage that a vehicle may posses when having the related estimate amount. Interior condition attribute, exterior condition attribute, and mechanical condition attribute inform about these various conditions of that the vehicle may posses when having the related estimate amount. Geographic location attribute may inform about the geographic location of the vehicle, such as, for example the home address of the customer. Color attribute may inform about the color used to obtain the estimate associated with this vehicle. Optional equipment attribute may inform about the optional equipment used to obtain the associated estimate. Data schema 300 may obtain information stored within used-vehicle valuation entity 312 by using a service of a used-vehicle estimation service (for example, see FIG. 2) and that many of the attributes of used-vehicle valuation entity 312 may alternatively be input parameters to such service.

These entities may be combined using programming techniques into sets of data that are usable for programming and processing. For example, a set of financial terms may combine financial agreement information from the financial entity with contact information from customer entity 302 and vehicle information from vehicle entity 308. Similarly, a set may be built that combines the various values required to complete the value-difference calculation. Such sets may be created by using forming SQL query and/or using a SQL cursor. Alternately, such a set may be created by using a database view. Alternately, such a set may be created using non-database techniques, such as, for example, using associative memory arrays or delimited operating system files or other techniques. The set may select related information from a variety of entities.

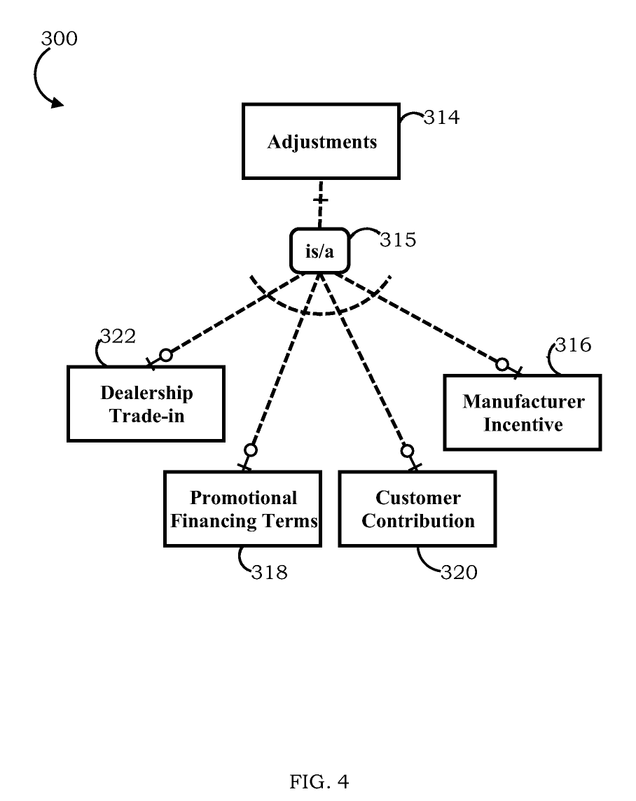

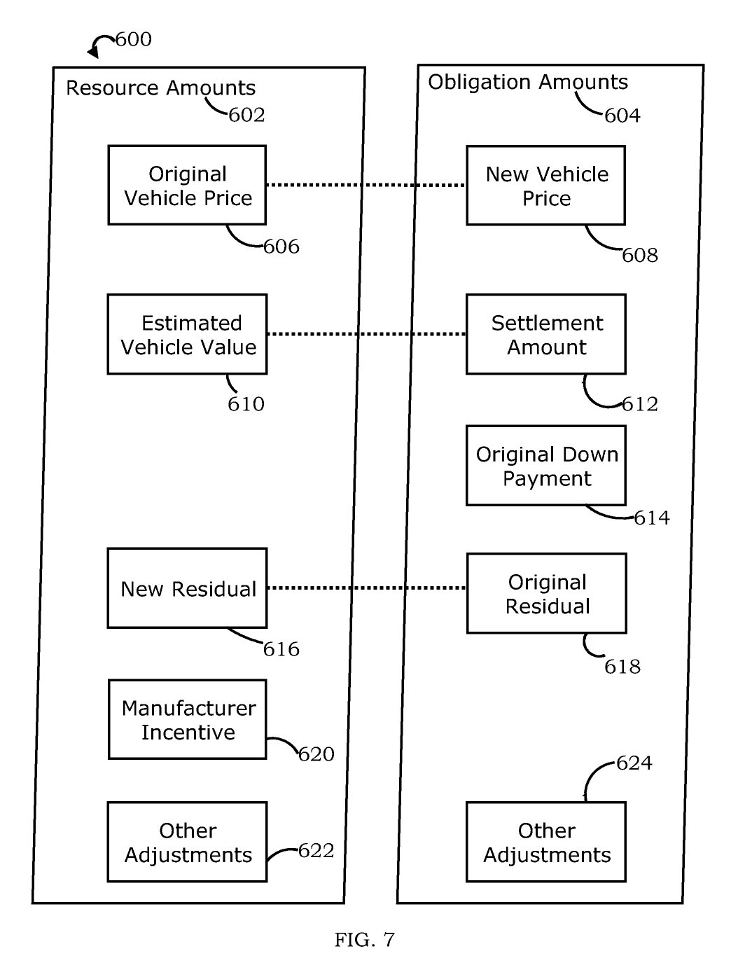

FIG. 4 shows an entity relationship diagram illustrating database entities storing adjustment information in a class/subclass relationship, according to the embodiment of FIG. 3. Adjustment entity 314 may contain attributes to organize data related to the types of adjustments that may be made during the purchase of a new vehicle, according to the data's purpose and the data-type. Adjustment entity may contain attributes to adjust the resources and obligations (for example, see FIG. 7 and accompanying text) of the purchaser when purchasing a new vehicle in exchange for the original vehicle. Adjustment entity 314 many contain attributes that relate to a specific vehicle make, vehicle model, and other vehicle classification information. Adjustment entity 314 may be organized into one or more sub classes, as shown. Each sub class entity may contain additional information related to the class of adjustment. For example, manufacturing incentive subclass 316 may contain attributes that indicate the expiration date of the incentive terms, or may indicate any pre-requisite conditions, such as, for example, friends and family discounts, employee discounts, loyalty programs, etcetera. Promotional financing terms subclass 318 may contain attributes that inform about the promotional interest rate (APR), or inform about changes in other financing terms, such as residual values, balloon payments, or other lease terms. For purposes of this application, balloon payment and residual value may both be types of residual cost information. Further, promotional financing terms subclass 318 may inform about pre-requisite conditions, such as, for example loyalty programs, minimum credit scores, minimum down payment or equity information, etcetera. Customer contribution subclass 320 may contain attributes that inform about the amount of cash that customers (or a specific customer) may be willing to pay to purchase a new vehicle. Dealership trading subclass 322 may contain attributes that inform about vehicles that the dealership may desire for its used car lot, variations in local values that may not be considered by the vehicle appraisal services, etcetera.

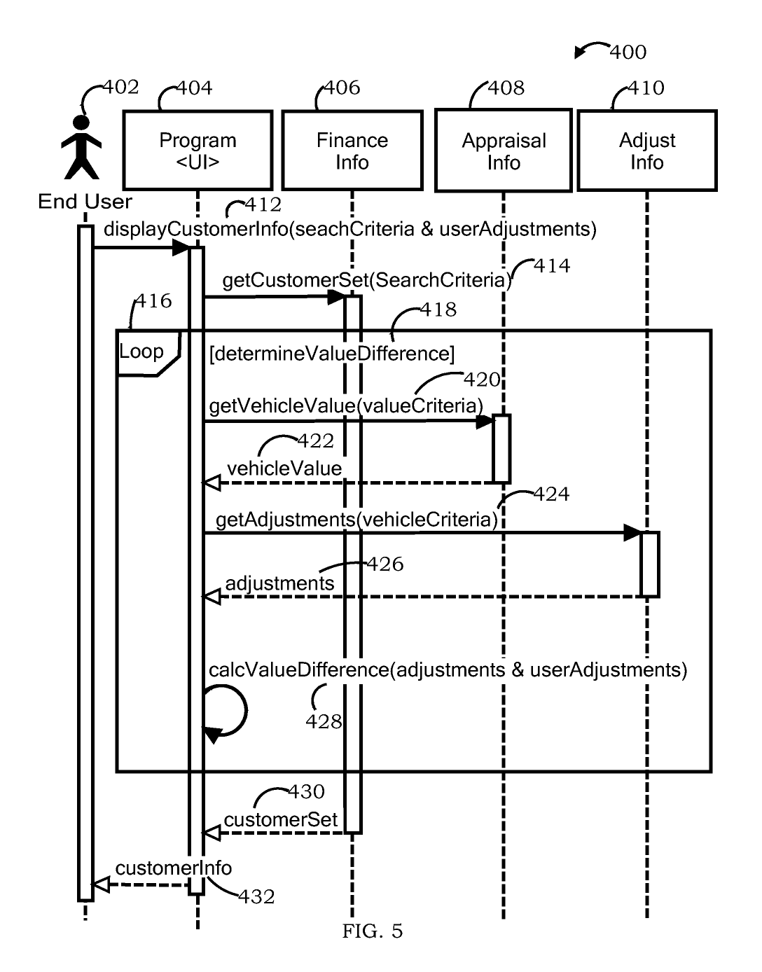

FIG. 5 shows a sequence diagram illustrating course of action 400 for a computer software program to determine the value-difference between the original financial terms and the new financial terms, according to an embodiment of the present invention. End-user 402 may operate a computer software program to find potential purchasers of a new vehicle, as shown. Course of action 400 may interact with various parts of the computer program, including user interface 404, finance information 406, appraisal information 408 and adjustment information 410, as shown. To begin, end user 402 may issue a request to the user interface 404 to display the customer info on the computer screen using displayCustomerInfo method 412, as shown. End user 402 may make this request when initially logging in to the computer software, when requesting a data refresh, when updating search criteria, when updating adjustment information, and at other times when it may be necessary to update the information displayed on the computer screen.

User interface 404 begins by obtaining a set of customer information by calling getCustomerSet method 414, as shown. getCustomerSet method 414 may use the search criteria specified by the user to obtain a set (or a subset) of customer records by querying finance info 406, as shown. In this embodiment, which may work for a variety of data storage types, user interface 404 may loop using determineValueDifference loop 416 on the set of customer info, as shown. Alternately, similar results may be accomplished using the SQL database language to join tables to obtain results from a single relational database query.

DetermineValueDifference loop 418 may repeatedly perform a series of actions to determine the value-difference for each customer in the customer set returned by getCustomerSet method 414, as shown. First, determineValueDifference loop 418 may invoke getVehicleValue method 420 using any value criteria specified by the finance info, such as, for example, vehicle classification data, vehicle age, an assumption of the average mileage, an assumption of the average vehicle condition for the vehicle age, and other information that may help insure an accurate estimate of the value of the original vehicle. Average mileage information may be obtained by researching vehicle valuation records for a particular retail geographical market. For example, in the UK, the first standard average band from vehicle valuation reports by CAP has a high correspondence rate with the average vehicle mileage. Standard mileage data may also be available from other compilers of used car information, such as, for example, Kelley Blue Book Black Book, Galves and others. Alternatively, the average vehicle mileage may be selected by the end-user. GetVehicleValue method 420 may return vehicleValue 422, as shown. VehicleValue 422 may be a single vehicle value, a range of values, or a set of linked-list expression of values that link a series of vehicle conditions to a series of vehicle estimates.

DetermineValueDifference loop 418 may continue by obtaining values that may be required or desirable to determine the value difference, as shown. DetermineValueDifference loop 418 may invoke getAdjustments method 424 using vehicle criteria, such as vehicle classification information (make, model, year of manufacture, etcetera). Alternately, other criteria, related to the various subclasses of adjustments (see FIG. 4 and accompanying text), may be used. GetAdjustments method 424 may return adjustments 426, which may be a set of adjustment values.

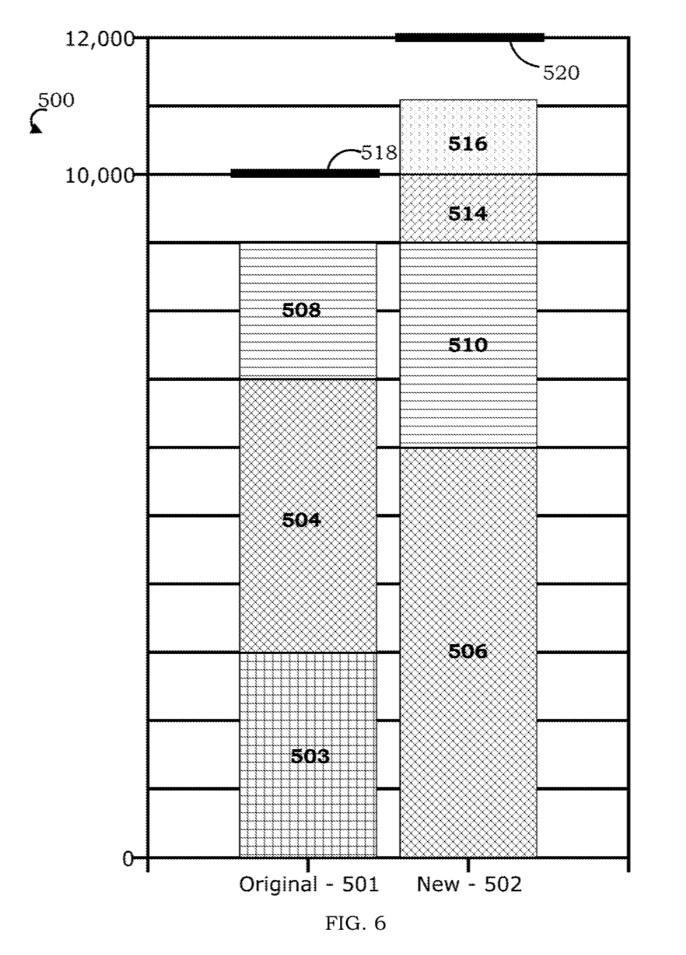

DetermineValueDifference loop 418 may continue by invoking the calcValueDifference methods 428, which uses adjustments 426 and userAdjustments (which may have been provided by the user when invoking displayCustomerInfo method 412), as shown. CalcValueDifference may determine the value difference between the original financial terms and the new financial terms. (See also FIGS. 6 to 8 and accompanying text below). DetermineValueDifference loop 418 may repeat these steps for each and every customer having information in the customer set, as shown.

Finally, getCustomerSet method 414 may return customerSet 430, including the value differences for display to end user 402 as customerInfo 432, as shown.

FIG. 6 shows bar graph 500 comparing the portions of the value of the original financial terms to the portions of the value of the new financial terms, according to an embodiment of the present invention. Bar graph 500 shows two bars stacked with values related to the original financing terms (original values 501) and the new financing terms (new values 502), as shown. Original values 501 may have four parts and indicates that the original vehicle is purchased for $10,000, as shown. New values 502 may have five parts, including one negative value that indicate that the new transaction is capable of generating $14,100 worth of buying power, as shown. The following example shows one way to determine a value difference between the two lease transactions.

The first part, down payment amount 503, shows that $3000 was contributed by the purchaser of the vehicle as the down payment. Down payment amount 503 appears as a positive value in original values 501, as shown. Down payment amount appears as a negative value in new values 502, as shown, because when the new values 502 can offset the original down payment amount, then the new financial terms (including the monthly payment amount) may be likely to be similar to the original financial terms. To begin, the value difference may be the negative down payment amount 503, or in this example, −$3000.

Next, settlement amount 504, in original values 501, shows $4000 remains to settle fully the terms of the original financial terms, as shown. Vehicle estimate amount 506, in new values 502, shows the vehicle is worth $6000 on the used car market. To determine the value difference so far, start with the −$3000 value difference found above, add the $6000 vehicle estimate amount 506 and subtract the $4000 settlement amount 504, to determine the new value difference of $0.

Next, residual amount 508, in original values 501, shows $2000 of value at the end of the lease term. Residual amount 510, in new values 502, shows $3000 of value at the end of the lease term. To determine the value difference so far, start with the −$1,000 value difference calculated above, subtract the $2000 original residual value 508, add the $3000 new residual value 510, to determine the value difference of $0, as shown.

Next, manufacturer incentive amount 514 shows $1000 of value when purchasing a new vehicle. To determine the value difference so far, start with the $0 value difference above, add the $1000 manufacturer incentive amount 514, to determine the value-difference of $1000, as shown.

Next, trading adjustment amount 516 shows $1100 of value because the dealership values this type of used car more than the vehicle estimate service. To determine the value difference so far, start with the $1000 value difference above, add the $1100 trading adjustment amount 516, to determine the value-difference of $2100, as shown.

Next, original vehicle price 518 is $10,000 and new vehicle price 520 is $12,000. To determine the value difference so far, start with the $4100 value difference above, add the original price of $10,000, subtract the new price of $12,000, to determine the value-difference of $100, as shown.

The following table shows the above calculations in tabular format.

| Description | Value | Running Total |
|---|---|---|
| Subtract down payment 503 | −$3,000 | −$3,000 |
| Add vehicle estimate amount 506 | +$6,000 | +$3,000 |
| Subtract settlement amount 504 | −$4,000 | −$1,000 |
| Add original residual amount 508 | −$2,000 | −$3,000 |
| Subtract new residual amount 510 | +$3,000 | $0 |
| Add manufacturer incentive amount 514 | +$1,000 | +$1,000 |
| Add trading amount 516 | +1,100 | +$2,100 |
| Add original vehicle price 518 | +10,000 | +$12,100 |
| Subtract new vehicle price 520 | −$12,000 | +$100 |
| Value Difference | | $100 |

Another way to express this is by the following formula:

| | |
|---|---|
| Add | vehicle estimate amount |
| Subtract | settlement amount |
| Subtract | down payment amount |
| Subtract | (new vehicle price - original vehicle price) |
| Add | (new residual amount - original residual amount) |
| Add | manufacturer incentive |
| Add | trading adjustment amount |
| Add | customer adjustment amount |
| Add | other adjustments amounts |
| Equals | Value-Difference |

The final value difference for this example shows $100, which means that this system would predict that this customer could trade his original vehicle for substantially the same financing terms for a new vehicle and have $100 left over. This example shows one way of calculating the value difference between an original financing agreement and a new financing agreement. Other methods of calculation may be used, for example, by adding additional values not relevant to this example, or by excluding values that may not be relevant to the local market, etc. The method of calculation need not perfectly predict the outcome of trading the original vehicle for a new vehicle (as this example shows), but rather, the calculation need only estimate the result so that any message sent to the customer (or other action taken) be substantially accurate.

FIG. 7 shows a data flow diagram illustrating data flow 600 for calculating the value difference between a new vehicle acquisition and the present value of a financed vehicle, according to an embodiment of the present invention. As the example given by FIG. 5 has shown, the various values can be added or subtracted from the value difference. Resource amounts 602 shows the various values that may generally have a positive effect on the value difference. Obligation amounts 605 shows the various values that may generally have a negative effect on the value difference. As noted above, this listing of values is not complete, rather, this listing of values was selected because of the limited information available prior to speaking to the customer about actual condition of the vehicle, variations in the actual settlement amount (as opposed to an estimated settlement amount), the actual mileage of the vehicle. In other words, the value difference is used to predict a likely customer for a specific sales message, and need not be perfectly accurate. Factors for consideration of the value difference may be selected based upon their ability to identify such customer.

Resource amounts 602 show several factors commonly used to positively affect the value difference, such as, for example, original vehicle price 606, estimated vehicle value 610, the original residual 616, manufacturer incentive 620, and other adjustments 622, as shown. Obligation Amounts 604 shows several factors commonly used to negatively affect the value difference, such as, for example, new vehicle price 608, settlement amount 612, original down payment 614, new residual 618, and other adjustments 624, as shown.

Further, certain values may be related, in other words, the accuracy of the value difference increase when the values are both considered in the value difference determination. For example, when considering original vehicle price 606 as a part of resource amount 602, then also consider new vehicle price 608 as a part of obligation amounts 604, as shown. For example, when considering estimated vehicle value 610 as a part of resource amounts 602, then also consider settlement amount 612 as a part of obligation amounts 604, as shown. For example, when considering the new residual 616 as part of resource amounts 602, then also consider original residual 618 as part of obligation amounts 604, as shown. Additionally, using the original down payment 614 to determine value differences may increase the accuracy of the prediction.

Returning briefly to the example started in FIG. 6, buying power shows the approximate highest value a customer may spend on a new vehicle. One way to determine the buying power would start by calculating the value difference, as just described. Next, the calculation continues by performing the following additional calculations to the value difference: adding the settlement amount 612, adding original vehicle purchase price 606, adding original down payment 614, and adding original residual 618. Turning again to the figures from FIG. 6, that example could be extended to determine buying power as follows:

| Description | Value | Running Total |
|---|---|---|
| Add value-difference | $100 | $100 |
| Add settlement amount 504 | +$4000 | +$4100 |
| Add original vehicle price 518 | +$10,000 | +14,100 |
| Add down payment amount 503 | +$3,000 | +$17,100 |
| Add original residual amount 508 | +$2,000 | +$19,100 |
| Buying Power | | $19,100 |

The buying power is $19,100, which represents the approximate highest value a customer may spend on a new vehicle from the example of FIG. 6.

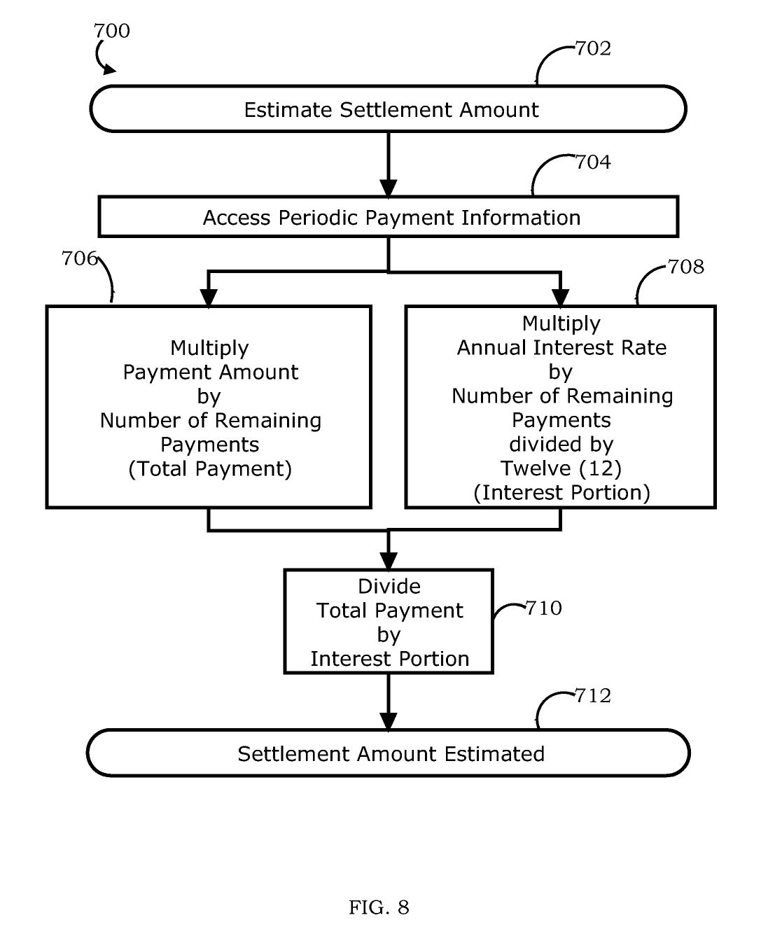

FIG. 8 shows a data flow diagram illustrating the process for calculating the remaining interest to be paid in order to remove such interest from consideration of the value difference, according to the financial terms of a vehicle acquisition, according to an embodiment of the present invention. Finance companies may not present an actual settlement amount when providing data to their affiliated dealerships. Estimating the settlement amount allows for calculation of value differences. Data flow 700 shows the steps that may be desirable to estimate the current settlement amount given only the monthly payment amount, the date the financing ends, the interest rate and the current date. To begin, data flow 700 starts with the estimate settlement amount step 702, as shown. Step 704 may access the periodic payment information, for example, the monthly payment amount, the date the financing ends, and the interest rate. The current date may be available from a computer operating system or from services available across the Internet. To determine the number of remaining payments, data flow 700 may count the number of months between the current date and the date the financing ends.

Step 706 may determine the total amount of the future payments by multiplying the monthly payment amount by the number of remaining payment periods (months). This value may estimate the total amount of remaining payments to be made by the purchaser. For example, if the current date is February 2008, and financing ends in February 2010, then 24 months remain in the financing agreement. If the monthly payment is $250, then the total of all payments would be $250*24 Months=$6,000.

Step 708 may determine the portion of the remaining payments that would be attributed to interest. The interest portion may be calculated by multiplying the annual percentage rate by the number or remaining payments and then dividing by 12 (the number of months in a year). So, for example, if the APR is 8.25%, and using the 24 months calculated above, then this would be (1.085*24/12=2.17) Step 710 determines the non-interest portion of the total payments, which is an estimate of the settlement amount. This may be calculated by dividing the Total Payment by the Interest Portion: ($6,000/2.17=$2765). In this example, $2,765 may estimate the current settlement amount of the financial terms of the original vehicle.

Vehicle loans follow the rule of 78, which is estimated above. However, financial products that have a residual value, such as leases, may not follow the rule of 78. To compensate, the sum of one months payment may be added to the settlement amount as a safety buffer in favor of the end user.

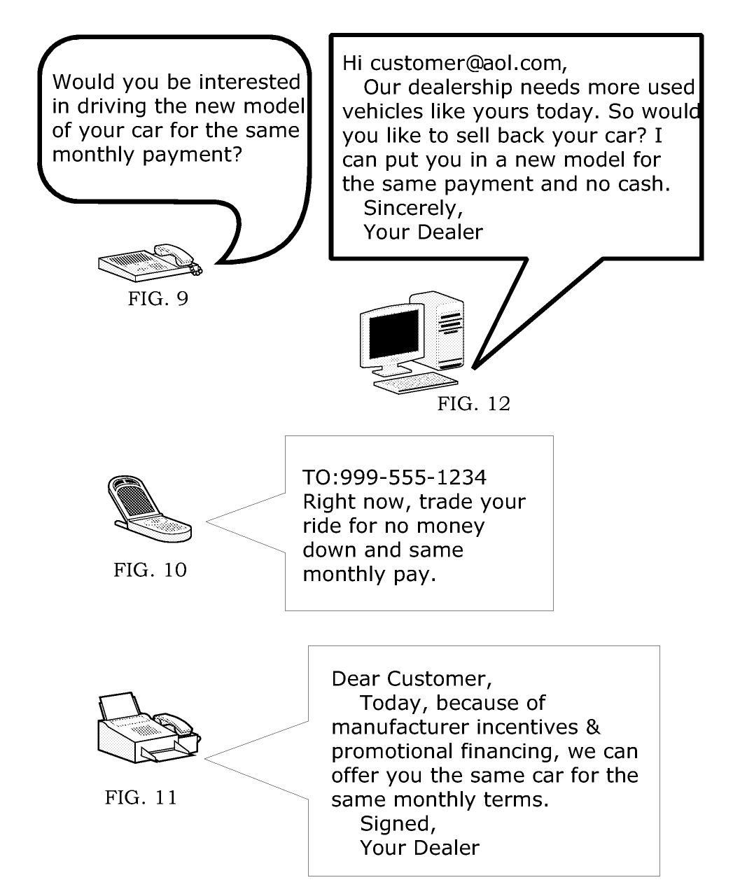

FIG. 9 shows a diagrammatic view illustrating a telephone correspondence between a vehicle dealer and a vehicle purchaser regarding the replacement of the original vehicle with a new vehicle without increasing payment, according to an embodiment of the present invention. FIG. 10 shows a diagrammatic view illustrating an automatically generated text message of correspondence to the purchaser regarding the replacement of the original vehicle with a new vehicle without increasing payment or requiring additional cash, according to an embodiment of the present invention. FIG. 11 shows a diagrammatic view illustrating an automatically generated facsimile message of correspondence to the purchaser regarding the replacement of the original vehicle with a new vehicle without increasing payment or requiring additional cash, according to an embodiment of the present invention. FIG. 12 shows a diagrammatic view illustrating an automatically generated email message of correspondence to the purchaser regarding the replacement of the original vehicle with a new vehicle without increasing payment or requiring additional cash, according to an embodiment of the present invention.

FIGS. 9 to 12 provide examples of message content and methods to communicate to potential purchasers. Message templates may be used by automated systems to personalize the message for the potential purchaser's situation. The following is a template for a message, suitable for transmittal by fax, email, or regular mail. Portions of the template may be indicated by <angle brackets>, as shown.
<Full Name>
<Address 1>
<Address 2>
<Town> <Post Code>
<Date> Our ref: <Registration Number>

Dear <FirstName>,
Over the past several days I have tried to make contact with you by telephone without success. Consequently I am writing in order to notify you about some valuable information regarding your <Model>.

### Your current finance agreement

Computer records from <Your Financial Institution> show that now is the most financially efficient moment for you to consider changing your car, even though you still have <Remaining Months> months to go on your current agreement.

### Why do you need to know this information?

You may not be considering changing your car just yet, but let us explain why this information is important to you. Data from <Your Financial Institution> indicates that when the current offers available through the <Manufacturer> retail network are combined with the estimated present value of your <Model>, they are sufficient to allow you to renew your <Model> for a new <Make>.
Best of all, this can be achieved without any requirement for cash input from you. Your monthly payment and finance term would simply be renewed without change. Naturally, changing your car when all of the market conditions are right can promote the lowest cost of driving.

### Cash Back

In some cases, customers could benefit from a cash-back sum. If applicable, you can decide how to use the value of the cash back, either by upgrading your vehicle specification, reducing your finance term or lowering your monthly payment. Of course you may also elect to take advantage of <Your Dealership> writing you a check for the sum along with delivery of your new car.

### No Catch or Obligation

Like you, I am more than aware that a lot of so-called ‘offers’ are not what they at first appear to be, but I can assure you that this opportunity is simply a case of prevailing market conditions and the current estimated value of your car combining in a way that brings you the freedom to make this decision. There are no hidden charges or figures you are not already aware of since the computer calculation replicates your current ‘deal’.

Naturally the above opportunity is subject to confirmation of mileage, condition and a short physical appraisal of your car since the computer assumes values based on averages within the system.

### Summary—a new car, with no cash input from you and no change to your monthly payments

If you'd like to drive a new car ‘now’, we would look forward to speaking with you to answer any questions that you may have. Please feel free to contact my Renewals Manager, <Your Salesperson> on <Your Dealership>, quoting your reference number as shown at the top of the page.
Yours sincerely
/signed/
<Your Sales Person Title>

Similarly, shorter messages may be appropriate for other message types, for example, text and instant messages may use shorter, precise messages or series of messages. For example:
Our computer system records from <Your Bank> show that NOW you can change your <Model>.
The value of your <Model> plus <Manufacter> incentives allow you to trade your old <Model> for a new <Model> with NO CHANGE to your monthly payment.
How many miles are on your <Model>? If the mileage is low, you might swap for a newer year with no upfront cash or change in monthly payment.
From 1-10, how clean is your <Model>? If the condition is good, you might swap for a newer year with no upfront cash or change in monthly payment.

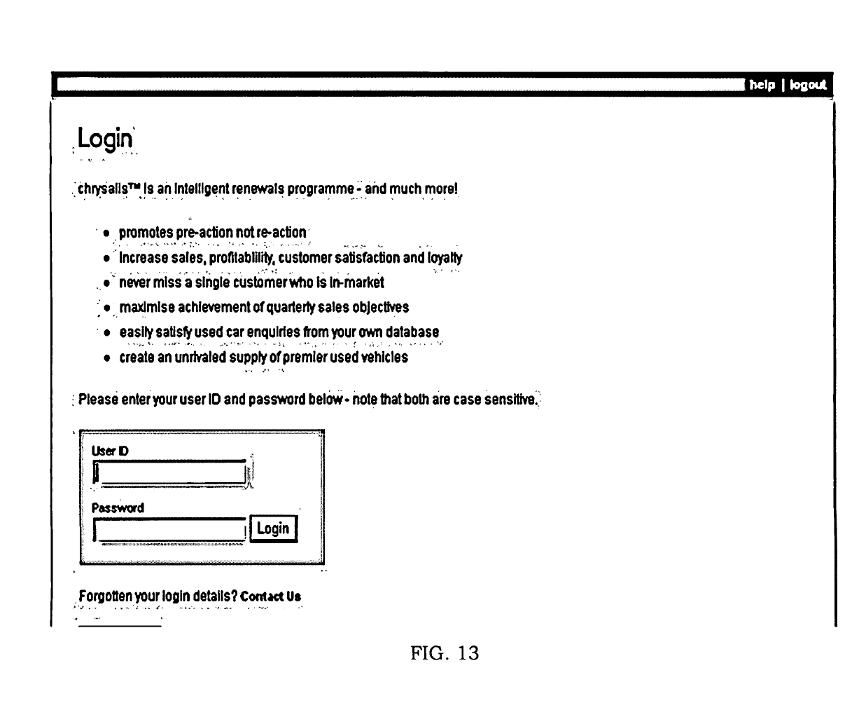

FIG. 13 shows a computer screenshot view illustrating web application 900 that contains a login screen for an end user, according to an embodiment of the present invention. The end user may enter user id 902 and password 904 before pressing the login button 906 to allow the web-server to authenticate these login credentials. Additionally, logout link 908 may be provided, which may delete any web browser cookie that the web server uses to keep track of the login status of the end user as the user navigates from one web page to the next within the computer system.

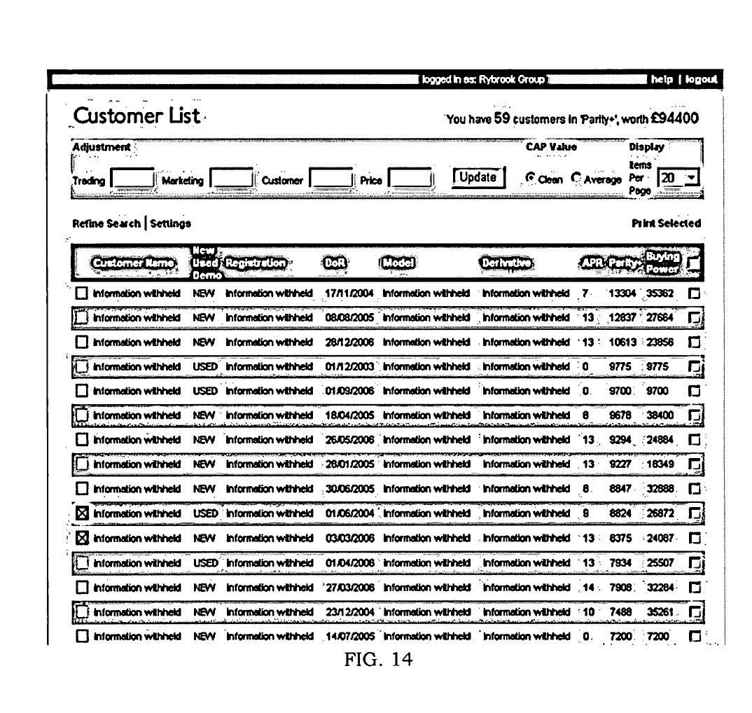

FIG. 14 shows a computer screenshot view illustrating how an end user may view purchaser information, according to an embodiment of the present invention. Web application 900 may allow display of information related to a purchaser, as shown. Web application displays contact-status field 912 to inform about the latest contact attempt for the purchaser, as shown. Contact-status field 912 may display whether or not contact has been made with the purchaser, whether or not a sale is pending with the purchaser, whether or not a sale has been made with a purchaser and whether or not the purchaser wishes the end-user to check back. Customer name field 914 shows the customer's name, as shown. New-used-demo field 916 shows the original condition of the vehicle at the time of this customer's purchase, such as, for example, a new vehicle, a used vehicle or a demo vehicle. Registration field 918 shows registration information for the purchaser's vehicle, as shown. Date of registration field 920 shows date that the customer took possession of the vehicle (and thereby started the financing agreement, if any), as shown. Model field 922 shows vehicle classification information, such as the vehicle make and model, as shown. APR field 924 shows the annual percentage rate interest for the financial terms associated with this purchaser for this vehicle, as shown. Parity+ field 928 shows the value difference between the original financing terms and new, potential financing terms for the same car, at the same price, with the same terms, as shown. Buying power field 930 may show the maximum attainable purchasing power that this particular purchaser can obtain by trading his original vehicle for a new vehicle of a newer model year, as shown. Selection checkbox 932 may allow selection of customer records for printing, exporting and other features requiring a selection of records. Message 933 displays the number of purchasers with sufficient value differences to allow the purchaser to trade the original vehicle for a new vehicle with no increase in monthly payment and no further cash deposit, as shown. Message 933 also displays an estimated value to the end user's dealership for completing all of these potential sales transactions, as shown.

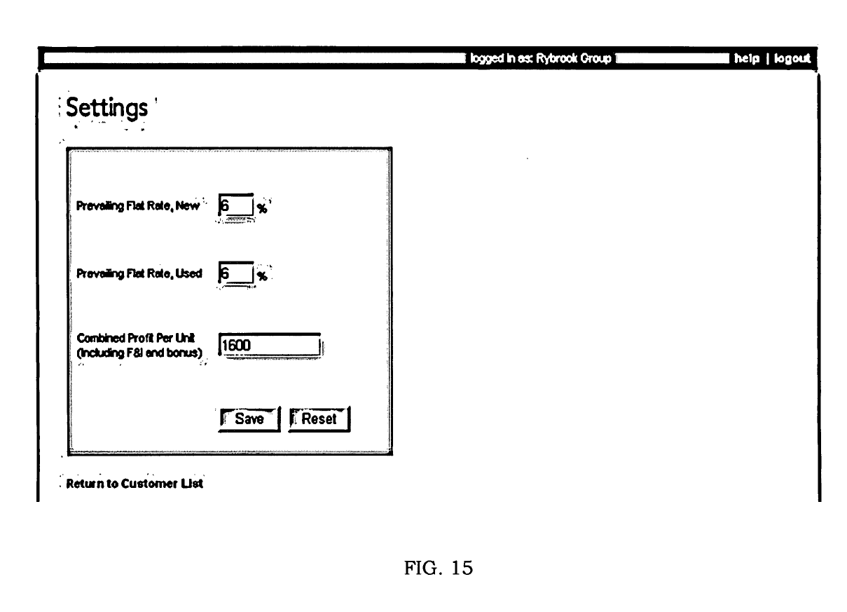

FIG. 15 shows a computer screenshot view illustrating how an end user may enter original interest information and new interest information, according to an embodiment of the present invention. Web application 900 allows entering adjustments to value differences, such as, for example the difference between the original interest rate and the current prevailing interest rate. New-vehicle prevailing-interest-rate field 934 and used-vehicle prevailing-interest-rate 936 allows the end user to enter the current prevailing interest rate (for comparison against the original interest rate) when determining value differences, as shown. Combined-profit-per-unit field 938 allows the end user to set a per-transaction value for displaying message 933, as shown.

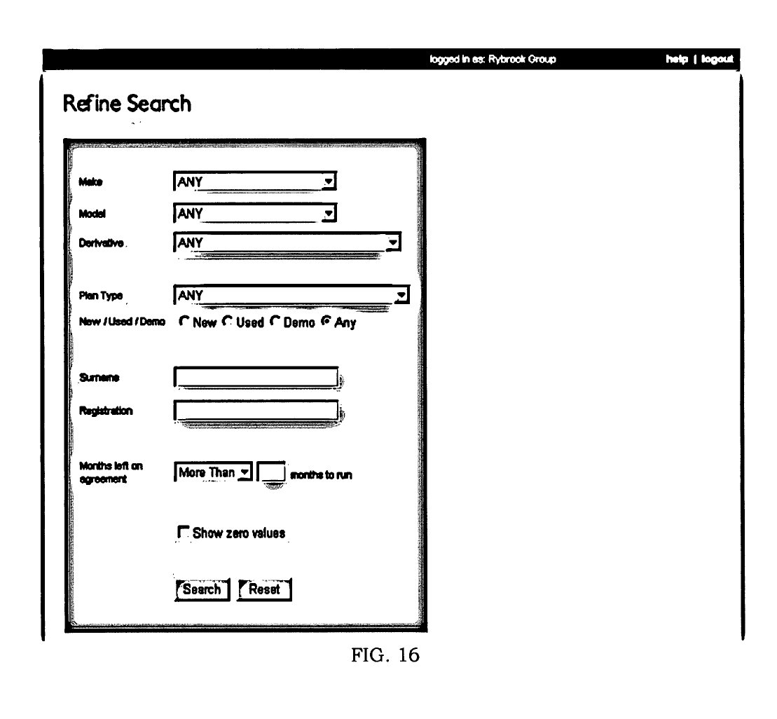

FIG. 16 shows a computer screenshot view illustrating how an end user may enter sorting criteria, such as vehicle make, vehicle model, financing type, and other details, according to an embodiment of the present invention. Web application 900 allows the end user to enter search criteria to limit the customer set that is displayed. For example, web application 900 allows searching by vehicle classification; including vehicle make field 940, vehicle model field 942, and vehicle derivative field 944, as shown. Note that as used in this application, vehicle model refers to the information that may be necessary to determine a vehicle estimate. For example, web application 900 allows searching by the type of financing using plan-type field 946, as shown. Web application 900 may allow searching by vehicle type using the new-used-demo field 948, as shown. Web application 900 may allow searching by customer name using surname field 950, as shown. Web application 900 may allow searching by vehicle registration information using registration field 952, as shown. Web application 900 may allow searching by the number of remaining months in the financing agreement using the months-to-run field 954, as shown. Web application may allow filtering by zero and/or null values by using show-zero-values field 956, as shown.

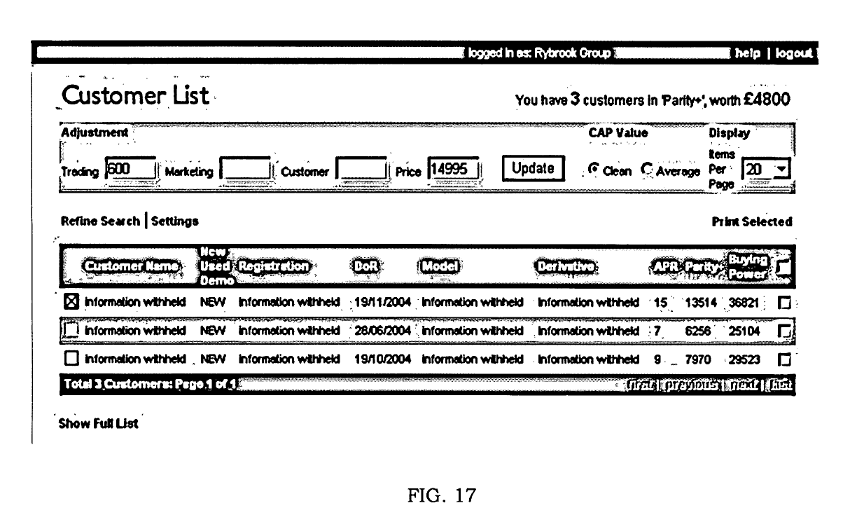

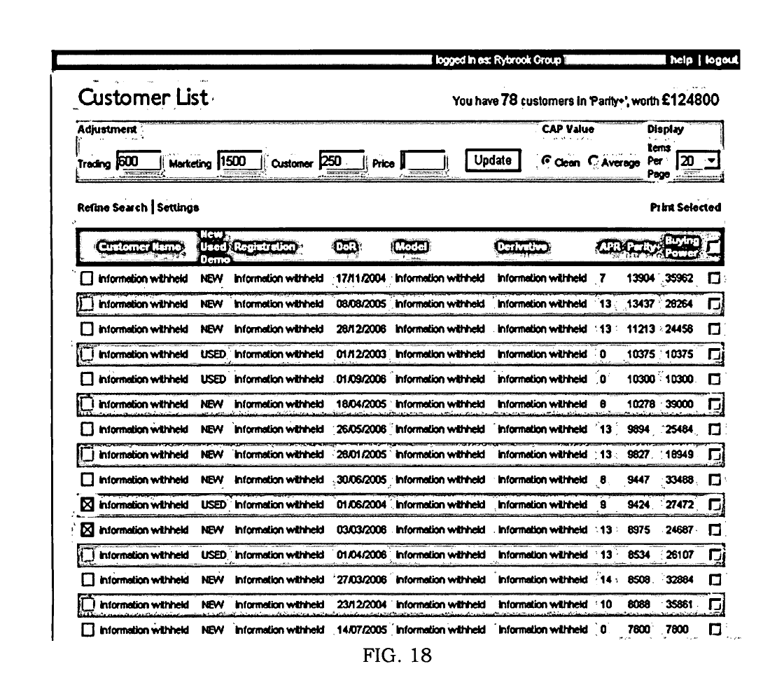

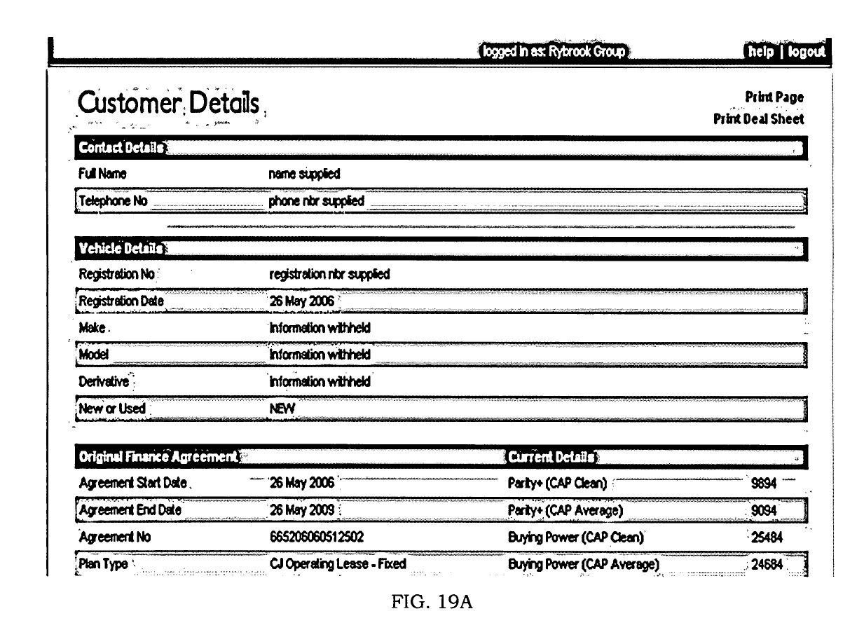

FIG. 17 shows a computer screenshot view illustrating how an end user may enter trading adjustments and the selling price of a new vehicle in order to re-determine the value difference for each purchaser, according to an embodiment of the present invention. FIG. 18 shows a computer screenshot view illustrating how an end user may enter trading, marketing, customer and price adjustment information without entering the selling price of a new vehicle in order to re-determine the value difference for each purchaser, according to an embodiment of the present invention. Now considering both FIG. 17 and FIG. 18, web application 900 allows end-user to input adjustments to the value differences using various fields, as shown. Trading adjustment field 958 many allow the end user to enter adjustments related to the dealerships view of the value of the purchaser's potential trade-in vehicle. Marketing adjustment field 960 may allow the end user to enter adjustment related to the manufacturer incentives, rebates, customer loyalty programs, employee purchase programs, etcetera. Customer adjustment field 962 may allow end user to enter adjustments related to any value (including additional cash down payment or an increase in monthly payments) the customer may contribute in order to effectuate the trading of the original vehicle for a new vehicle of the same make and model but newer model year, as shown. Price adjustment field 964 may allow the end user to enter the new selling price for the new vehicle, as shown. Web application 900 may allow end user to indicate cap value field 966 which will serve as a criteria for estimating vehicle values by specifying a particular vehicle condition, such as, for example, “average”, or “clean”, as shown. FIG. 17 shows three customers with sufficient value-differences. After making a variety of adjustments, FIG. 18 shows seventy-eight customers with sufficient value-differences.

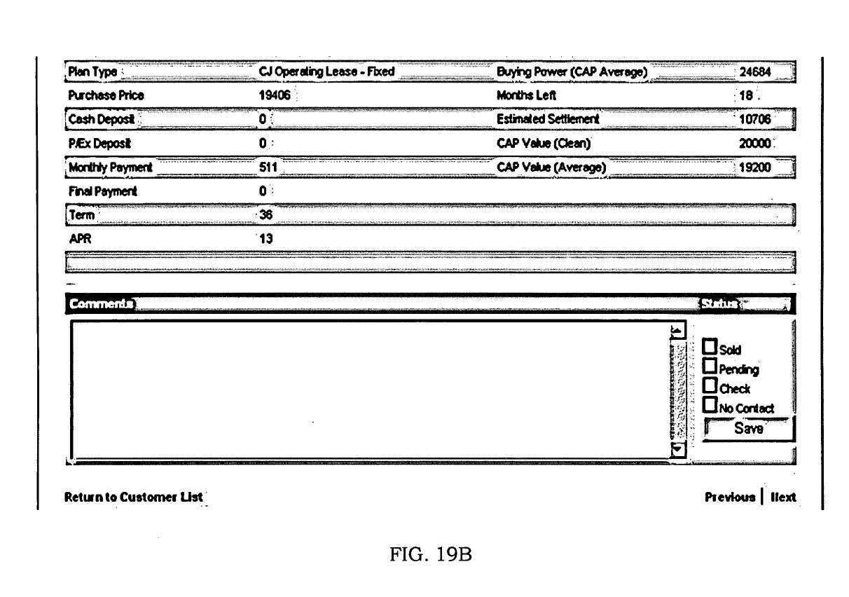

FIG. 19A shows a top-half of computer screenshot view and FIG. 19B shows a bottom-half of the same view illustrating how an end user may view contact information (and related financial and vehicle information) for a purchaser in order to deliver a message regarding the replacement of their vehicle, according to an embodiment of the present invention. The first portion of the screenshot shows information related to contacting the customer. Full name field 970 shows the name of the purchaser, as shown. Telephone number field 971 shows the telephone number of the purchaser, as shown.

The second portion of the screenshot shows information related to the vehicle owned by the customer, as shown. Registration number field 972 shows the registration information of the vehicle, as shown. Registration date field 973 shows the date of registration of the vehicle, as shown. Made field 974 shows the vehicle make information, as shown. Model field 975 shows the vehicle model information, as shown. Derivative field 976 shows additional information for classifying the vehicle, such as, for example, a two-door versus a four-door body style, as shown.

New-or-used field 977 shows whether the vehicle was originally purchased by this purchaser as a new, used or demo vehicle, as shown.

The third portion of the screenshot shows the terms of the original financing agreement, as shown. Agreement start date field 978 shows the date that the agreement began, usually the date that the purchaser takes possession of the vehicle, as shown. Agreement end date field 979 shows the date that the agreement may terminate if the agreement is not terminated early, as shown. Agreement number field 980 shows the number assigned to the financing agreement by the finance institution, as shown. Plan type field 981 shows the type of financing, such as, for example, conventional loan, open-end lease, close-end lease, etc. Parity-plus-CAP-clean field 982 shows the value-difference for the vehicle whenever the vehicle has a clean interior and exterior condition, as shown. Parity-plus-CAP-average field 983 shows the value-difference of the vehicle whenever the vehicle has an average interior and exterior condition, as shown. Buying power field 994 shows the highest cash value that this customer may be able to spend on a new vehicle, as shown. Estimated settlement field 996 shows the estimated amount to settle the terms of the financing agreement, as shown. CAP-value-clean field 997 shows the value of the vehicle on the used car market when the vehicle has a clean interior and exterior condition, as shown. CAP-value-average field 998 shows the value of the vehicle on the used car market when the vehicle has an average interior and exterior condition, as shown. Status field 999 shows the current status of this customer, for example, “No Contact” may mean that the customer is not interested, “Check” may mean that the customer was unavailable but would appreciate a call back later, “Pending” may mean that the customer has scheduled an sales appointment, “Sold” may mean that the customer has traded this vehicle for another vehicle, as shown. Other status may be used depending on the message, message type and message transmittal methods.

Although Applicant has described Applicant's preferred embodiments of this invention, it will be understood that the broadest scope of this invention includes modifications and implementations apparent to those skilled in the art after reading the above specification and the below claims. Such scope is limited only by the below claims as read in connection with the above specification. Further, many other advantages of Applicant's invention will be apparent to those skilled in the art from the above descriptions and the below claims.

What is claimed is:

1. A system comprising the steps of:
electronically accessing at least one financial-terms set related to the financial terms of the acquisition of at least one vehicle by at least one purchaser, wherein such financial-terms set comprises
contact information to inform about at least one method to contact the purchaser of such vehicle,
vehicle information to inform about such vehicle, and
settlement amount information to inform about the current amount required to settle any amount owed according to the financial terms of the acquisition;
electronically accessing at least one used-vehicle-valuation set, wherein such used-vehicle-valuation set comprises
an estimate amount to estimate the current value of at least one used vehicle, and
vehicle-characterizing information to inform about the characteristics related to the selection of such estimate amount;
automatically correlating such financial-terms set and such used-vehicle-valuation set,
wherein the step of correlating comprises the step of comparing such vehicle information to vehicle-characterizing information;
automatically determining at least one value-difference between at least one obligation amount and at least one resource amount to differentiate whether the purchaser that can satisfy substantially the entire such obligation amount using such resource amount,
wherein such obligation amount comprises such settlement amount information, and
wherein such resource amount comprises such estimate amount;
specifying at least one message to the purchaser, whenever such value-difference indicates that the purchaser can satisfy such obligation amount using such resource amount, to communicate that the purchaser can presently replace such vehicle; and
transmitting such message to the purchaser using the contact information.

2. The claim of claim 1 wherein:
such vehicle comprises a vehicle-type selected from the group consisting of private passenger automobile, private passenger light truck, and private passenger van;
such vehicle information further comprises
vehicle-make information to inform about the manufacturer of such vehicle,
vehicle-model information to inform about the model of such vehicle,
vehicle-year information to inform about the year of manufacture of such vehicle;
such vehicle-classification information further comprises
vehicle-make information to inform about the manufacturer related to the selection of such estimate amount,
vehicle-model information to inform about the model related to the selection of such estimate amount,
vehicle-year information to inform about the year of manufacture related to the selection of such estimate amount.

3. The claim of claim 2 further comprising the step of:
allowing sorting of such financial-terms set by such value-difference.

4. The claim of claim 3 wherein:
such message further communicates that the purchaser can presently replace the vehicle without increasing any periodic payment.

5. The claim of claim 4 wherein:
such message further communicates that the purchaser can presently replace the vehicle by increasing the number of periodic payments.

6. The claim of claim 2 wherein:
such vehicle information further comprises
vehicle-color information to inform about the original color of such vehicle, and
vehicle-equipment information to inform about any equipment installed on the vehicle at the time of acquisition; and
such vehicle-classification information further comprises
vehicle-color information to inform about the color related to the selection of such estimate amount, and
vehicle-equipment information to inform about any installed equipment related to the selection of such estimate amount.

7. The claim of claim 6 wherein:
such financial-terms set further comprises
purchase date to inform about the date of purchase of such vehicle;
such contact information further comprises
geographic-location information to inform about the location of the purchaser;
such vehicle-classification information further comprises
vehicle-mileage information to inform about the number of miles traveled related to the selection of such estimate,
vehicle-condition information to inform about the condition related to the selection of such estimate,
vehicle-location information to inform about the geographic location related to the selection of such estimate;
the step of automatically correlating further comprises the steps of
estimating at least one vehicle-mileage estimate of such vehicle by considering the amount of time between such purchase date and the present date,
comparing such vehicle-mileage estimate to related such vehicle-mileage information,
comparing an average vehicle condition to related such vehicle-condition information,
comparing such geographic-location information to related such vehicle-location information.

8. The claim of claim 2 wherein:
such financial-terms set further comprises
deposit information to inform of the original deposit paid by the purchaser for such vehicle;
wherein such obligation amount further comprises such deposit information.

9. The claim of claim 2 further comprising the step of:
accepting at least one adjustment-information set related to adjusting the financial terms of the purchase of a new vehicle, wherein such adjustment-information set comprises,
new-price information to inform about the present purchase price of the new vehicle,
wherein such financial-terms set further comprises
original-price information to inform about the original purchase priced paid by the purchaser for such vehicle;
wherein such obligation amount further comprises such new-price information;
wherein such resource amount further comprises such original-price information; and
wherein such message further communicates that such vehicle may be replaced by the new vehicle.

10. The claim of claim 2 further comprising the step of:
accepting at least one adjustment-information set related to adjusting the financial terms of the purchase of a new vehicle, wherein such adjustment-information set comprises,
new-residual-cost information to inform about any cost payable at the termination of the financial terms of the acquisition of the new vehicle;
wherein such financial-terms set further comprises
original-residual-cost information to inform about any cost payable at the termination of the financial terms of the acquisition of such vehicle,
wherein such resource amount further comprises such new-residual-cost information; and
wherein such obligation amount further comprises such original-residual-cost information;
wherein such message further communicates that such vehicle may be replaced by the new vehicle.

11. The claim of claim 2 further comprising the step of:
accepting at least one adjustment-information set related to adjusting the financial terms of the purchase of a new vehicle, wherein such adjustment-information set comprises,
new-interest information to inform about any interest payable according to the financial terms of the acquisition of the new vehicle;
wherein such financial-terms set further comprises
original-interest information to inform about any interest payable according to the financial terms of the acquisition of such vehicle;
wherein such resource amount further comprises such new-interest information; and
wherein such obligation amount further comprises such original-interest information;
wherein such message further communicates that such vehicle may be replaced by the new vehicle.

12. The claim of claim 2 wherein:
such contact information comprises
at least one telephone number of the purchaser; and
further comprising the steps of
automatically dialing such telephone number on at least one telephone network; and
recording at least one result of the step of automatically dialing.

13. The claim of claim 2 wherein:
such contact information comprises
at least one email address of the purchaser; and
wherein the step of specifying such message occurs automatically; and
wherein the step of transmitting occurs by email correspondence across a globally connected computer network.

14. The claim of claim 2 wherein:
such contact information comprises
at least one facsimile number of the purchaser;
wherein the step of specifying such message occurs automatically; and
wherein the step of transmitting occurs by facsimile correspondence across a telephone network.

15. The claim of claim 2 wherein:
such contact information comprises
at least one text-messaging address of the purchaser;
wherein the step of specifying such message occurs automatically; and
wherein the step of transmitting occurs by text-messaging correspondence across a wireless network.

16. A computer system comprising the steps of:
electronically accessing at least one financial-terms set related to the financial terms of the acquisition of at least one vehicle by at least one purchaser, wherein such financial-terms set comprises
contact information to inform about at least one method to contact the purchaser of such vehicle,
vehicle information to inform about such vehicle acquired by the purchaser, wherein such vehicle information further comprises
vehicle-make information to inform about the manufacturer of such vehicle,
vehicle-model information to inform about the model of such vehicle,
vehicle-year information to inform about the year of manufacture of such vehicle;
original-price information to inform about the original purchase priced paid by the purchaser for such vehicle;
settlement amount information to inform about the current amount required to settle any amount owed on such vehicle;
electronically accessing at least one used-vehicle-valuation set, wherein such used-vehicle-valuation set comprises
an estimate amount to estimate the current value of at least one used vehicle,
vehicle-characterizing information to inform about the characteristics related to the selection of such estimate amount, wherein such vehicle-classification information further comprises
vehicle-make information to inform about the manufacturer related to the selection of such estimate amount,
vehicle-model information to inform about the model related to the selection of such estimate amount,
vehicle-year information to inform about the year of manufacture related to the selection of such estimate amount;
accepting at least one adjustment-information set related to adjusting the financial terms of the purchase of a new vehicle, wherein such adjustment-information set comprises,
new-price information to inform of the present purchase price of the new vehicle,
automatically correlating such financial-terms set, such used-vehicle-valuations set, and such adjustment-information set,
wherein the step of correlating comprises the step of comparing such vehicle information to vehicle-characterizing information;
automatically determining at least one value-difference between at least one obligation amount and at least one resource amount to differentiate whether the purchaser that can satisfy substantially the entire such obligation amount using such resource amount,
wherein such obligation amount comprises such settlement amount information and such new-price information,
wherein such resource amount comprises such estimate amount and such original-price information; and
allowing sorting by such value-difference.

17. The claim of claim 16 wherein:
such vehicle comprises a vehicle-type selected from the group consisting of private passenger automobile, private passenger light truck, and private passenger van.

18. The claim of claim 17 wherein:
such vehicle information further comprises
vehicle-color information to inform about the original color of such vehicle,
vehicle-equipment information to inform about any equipment installed by the manufacturer and the dealer on the vehicle at the time of sale;
such vehicle-classification information further comprises
vehicle-color information to inform about the color related to the selection of such estimate amount,
vehicle-equipment information to inform about any installed equipment related to the selection of such estimate amount.

19. The claim of claim 18 wherein:
such financial-terms set further comprises
purchase date to inform about the date of purchase of such vehicle;
such contact information further comprises
geographic location information to inform about the location of the purchaser;
such vehicle-classification information further comprises
vehicle-mileage information to inform about the number of miles traveled related to the selection of such estimate,
vehicle-condition information to inform about the condition related to the selection of such estimate,
vehicle-location information to inform about the condition related to the selection of such estimate;
the step of automatically correlating further comprises the steps of
estimating at least one vehicle-mileage estimate of such vehicle by considering the amount of time between such purchase date and the present date,
comparing such vehicle-mileage estimate to similar such vehicle-mileage information,
comparing an average vehicle condition to such vehicle-condition information,
comparing such geographic location information to such vehicle-location information.

20. The claim of claim 17 wherein:
such financial-terms set further comprises
deposit information to inform of the original deposit paid by the purchaser for such vehicle;
wherein such obligation amount further comprises such deposit information.

21. The claim of claim 17 further comprising the step of:
receiving at least one adjustment-information set related to adjusting the financial terms of the purchase of a new vehicle, wherein such adjustment-information set comprises,
new-residual-cost information to inform about any cost payable at the termination of the financial terms of the acquisition of the new vehicle;
wherein such financial-terms set further comprises
original-residual-cost information to inform of any cost payable at the termination of the financial terms of the acquisition of such vehicle,
wherein such resource amount further comprises such new-residual-cost information; and
wherein such obligation amount further comprises such original-residual-cost information.

22. The claim of claim 17 further comprising the step of:
accepting at least one adjustment-information set related to adjusting the financial terms of the purchase of a new vehicle, wherein such adjustment-information set comprises,
new-interest information to inform about any interest payable according to the financial terms of the acquisition of the new vehicle;
wherein such financial-terms set further comprises
original-interest information to inform about any interest payable according to the financial terms of the acquisition of such vehicle;
wherein such resource amount further comprises such new-interest information; and
wherein such obligation amount further comprises such original-interest information.

23. A computer system comprising the steps of:
electronically accessing at least one financial-terms set related to the financial terms of the acquisition of at least one vehicle by at least one purchaser, wherein such financial-terms set comprises
contact information to inform about at least one method to contact the purchaser of such vehicle,
vehicle information to inform about such vehicle acquired by the purchaser, wherein such vehicle information further comprises
vehicle-make information to inform about the manufacturer of such vehicle,
vehicle-model information to inform about the model of such vehicle,
vehicle-year information to inform about the year of manufacture of such vehicle;
original-residual-cost information to inform of any cost payable at the termination of the financial terms of the acquisition of such vehicle;
settlement amount information to inform about the current amount required to settle any amount owed on such vehicle;
electronically accessing at least one used-vehicle-valuation set, wherein such used-vehicle-valuation set comprises
an estimate amount to estimate the current value of at least one used vehicle,
vehicle-characterizing information to inform about the characteristics related to the selection of such estimate amount, wherein such vehicle-classification information further comprises
vehicle-make information to inform about the manufacturer related to the selection of such estimate amount,
vehicle-model information to inform about the model related to the selection of such estimate amount,
vehicle-year information to inform about the year of manufacture related to the selection of such estimate amount;
accepting at least one adjustment-information set related to adjusting the financial terms of the purchase of a new vehicle, wherein such adjustment-information set comprises,
new-residual-cost information to inform about any cost payable at the termination of the financial terms of the acquisition of the new vehicle,
automatically correlating such financial-terms set, such used-vehicle-valuations set, and such adjustment-information set,
wherein the step of correlating comprises the step of comparing such vehicle information to vehicle-characterizing information;
automatically determining at least one value-difference between at least one obligation amount and at least one resource amount to differentiate whether the purchaser that can satisfy substantially the entire such obligation amount using such resource amount,
wherein such obligation amount comprises such settlement amount information and such original-residual-cost information,
wherein such resource amount comprises such estimate amount and such new-residual-cost information; and
allowing sorting by such value-difference.

24. The claim of claim 23 wherein:
such vehicle comprises a vehicle-type selected from the group consisting of private passenger automobile, private passenger light truck, and private passenger van.

25. The claim of claim 24 wherein:
such vehicle information further comprises
vehicle-color information to inform about the original color of such vehicle,
vehicle-equipment information to inform about any equipment installed by the manufacturer and the dealer on the vehicle at the time of sale;
such vehicle-classification information further comprises
vehicle-color information to inform about the color related to the selection of such estimate amount,
vehicle-equipment information to inform about any installed equipment related to the selection of such estimate amount.

26. The claim of claim 25 wherein:
such financial-terms set further comprises
purchase date to inform about the date of purchase of such vehicle;
such contact information further comprises
geographic location information to inform about the location of the purchaser;
such vehicle-classification information further comprises
vehicle-mileage information to inform about the number of miles traveled related to the selection of such estimate,
vehicle-condition information to inform about the condition related to the selection of such estimate,
vehicle-location information to inform about the condition related to the selection of such estimate;
the step of automatically correlating further comprises the steps of
estimating at least one vehicle-mileage estimate of such vehicle by considering the amount of time between such purchase date and the present date,
comparing such vehicle-mileage estimate to similar such vehicle-mileage information,
comparing an average vehicle condition to such vehicle-condition information,
comparing such geographic location information to such vehicle-location information.

27. The claim of claim 24 wherein:
such financial-terms set further comprises
deposit information to inform of the original deposit paid by the purchaser for such vehicle;
wherein such obligation amount further comprises such deposit information.

28. The claim of claim 24 further comprising the step of:
accepting at least one adjustment-information set related to adjusting the financial terms of the purchase of a new vehicle, wherein such adjustment-information set comprises,
new-price information to inform about the present purchase price of the new vehicle,
wherein such financial-terms set further comprises
original-price information to inform about the original purchase priced paid by the purchaser for such vehicle;
wherein such obligation amount further comprises such new-price information;
wherein such resource amount further comprises such original-price information.

29. The claim of claim 24 further comprising the step of:
accepting at least one adjustment-information set related to adjusting the financial terms of the purchase of a new vehicle, wherein such adjustment-information set comprises,
new-interest information to inform about any interest payable according to the financial terms of the acquisition of the new vehicle;
wherein such financial-terms set further comprises
original-interest information to inform about any interest payable according to the financial terms of the acquisition of such vehicle;
wherein such resource amount further comprises such new-interest information; and
wherein such obligation amount further comprises such original-interest information.

30. A computer system comprising the steps of:
electronically accessing at least one financial-terms set related to the financial terms of the acquisition of at least one vehicle by at least one purchaser, wherein such financial-terms set comprises
contact information to inform about at least one method to contact the purchaser of such vehicle,
vehicle information to inform about such vehicle acquired by the purchaser, wherein such vehicle information further comprises
vehicle-make information to inform about the manufacturer of such vehicle,
vehicle-model information to inform about the model of such vehicle,
vehicle-year information to inform about the year of manufacture of such vehicle;
original-interest information to inform about any interest payable according to the financial terms of the acquisition of such vehicle;
settlement amount information to inform about the current amount required to settle any amount owed on such vehicle;
electronically accessing at least one used-vehicle-valuation set, wherein such used-vehicle-valuation set comprises
an estimate amount to estimate the current value of at least one used vehicle,
vehicle-characterizing information to inform about the characteristics related to the selection of such estimate amount, wherein such vehicle-classification information further comprises
vehicle-make information to inform about the manufacturer related to the selection of such estimate amount,
vehicle-model information to inform about the model related to the selection of such estimate amount,
vehicle-year information to inform about the year of manufacture related to the selection of such estimate amount;
accepting at least one adjustment-information set related to adjusting the financial terms of the purchase of a new vehicle, wherein such adjustment-information set comprises,
new-interest information to inform about any interest payable according to the financial terms of the acquisition of the new vehicle,
automatically correlating such financial-terms set, such used-vehicle-valuations set, and such adjustment-information set,
wherein the step of correlating comprises the step of comparing such vehicle information to vehicle-characterizing information;
automatically determining at least one value-difference between at least one obligation amount and at least one resource amount to differentiate whether the purchaser that can satisfy substantially the entire such obligation amount using such resource amount,
wherein such obligation amount comprises such settlement amount information and such original-interest information,
wherein such resource amount comprises such estimate amount and such new-interest information; and
allowing sorting by such value-difference.

31. The claim of claim 30 wherein:
such vehicle comprises a vehicle-type selected from the group consisting of private passenger automobile, private passenger light truck, and private passenger van.

32. The claim of claim 31 wherein:
such vehicle information further comprises
vehicle-color information to inform about the original color of such vehicle,
vehicle-equipment information to inform about any equipment installed by the manufacturer and the dealer on the vehicle at the time of sale;
such vehicle-classification information further comprises
vehicle-color information to inform about the color related to the selection of such estimate amount,
vehicle-equipment information to inform about any installed equipment related to the selection of such estimate amount.

33. The claim of claim 32 wherein:
such financial-terms set further comprises
purchase date to inform about the date of purchase of such vehicle;
such contact information further comprises
geographic location information to inform about the location of the purchaser;
such vehicle-classification information further comprises
vehicle-mileage information to inform about the number of miles traveled related to the selection of such estimate,
vehicle-condition information to inform about the condition related to the selection of such estimate,
vehicle-location information to inform about the condition related to the selection of such estimate;
the step of automatically correlating further comprises the steps of
estimating at least one vehicle-mileage estimate of such vehicle by considering the amount of time between such purchase date and the present date,
comparing such vehicle-mileage estimate to similar such vehicle-mileage information,
comparing an average vehicle condition to such vehicle-condition information,
comparing such geographic location information to such vehicle-location information.

34. The claim of claim 31 wherein:
such financial-terms set further comprises
deposit information to inform of the original deposit paid by the purchaser for such vehicle;
wherein such obligation amount further comprises such deposit information.

35. The claim of claim 31 further comprising the step of:
accepting at least one adjustment-information set related to adjusting the financial terms of the purchase of a new vehicle, wherein such adjustment-information set comprises,
new-price information to inform about the present purchase price of the new vehicle,
wherein such financial-terms set further comprises
original-price information to inform about the original purchase priced paid by the purchaser for such vehicle;
wherein such obligation amount further comprises such new-price information;
wherein such resource amount further comprises such original-price information.

36. The claim of claim 31 further comprising the step of:
accepting at least one adjustment-information set related to adjusting the financial terms of the purchase of a new vehicle, wherein such adjustment-information set comprises,
new-interest information to inform about any interest payable according to the financial terms of the acquisition of the new vehicle;
wherein such financial-terms set further comprises
original-interest information to inform about any interest payable according to the financial terms of the acquisition of such vehicle;
wherein such resource amount further comprises such new-interest information; and
wherein such obligation amount further comprises such original-interest information.
